(19) United States
(12) Patent Application Publication
(10) Pub. No.: US 2016/0092406 A1
(43) Pub. Date: Mar. 31, 2016

(54) Inferring Layout Intent

(71) Applicant: Microsoft Technology Licensing, LLC, Redmond, WA (US)

(72) Inventors: Karim Farouki, Seattle, WA (US); David Benjamin Lee, Sammamish, WA (US); Marko Rakita, Novi Sad (RS); Dusan Lukic, Belgrade (RS); Milos Raskovic, Belgrade (RS); Dragan Slaveski, Belgrade (RS); Aljosa Obuljen, Novi Beograd (RS); Milan Sesum, Narodnih heroja (RS)

(21) Appl. No.: 14/503,216

(22) Filed: Sep. 30, 2014

(51) Int. Cl. G06F 17/21; G06K 9/62; G06K 9/00

(52) U.S. Cl. CPC G06F 17/212; G06K 9/00456; G06K 9/00463; G06K 9/6227

(57) ABSTRACT

Technologies are described herein for inferring the layout intent associated with explicitly formatted document elements in a document. The layout type of a document having explicitly formatted document elements is determined. Once the layout type for the document has been determined, the layout intent of explicitly formatted document elements in the document may be determined based, at least in part, on the determined layout type of the document. Heuristic algorithms and/or machine learning classifiers may determine the layout intent of the explicitly formatted document elements in the document. An intent-based document is then created using the inferred layout intent for some or all of the explicitly formatted document elements in the document. The intent-based document may then be provided to an intent-based rendering or authoring application for rendering based upon the inferred layout intent.

### BACKGROUND

Most types of content in electronic documents today have been defined using explicit formatting information, rather than format intent information. For example, a presentation document might include text that has been explicitly formatted as bold or italicized rather than text that is defined as emphasized. As another example, a word processing document might include data explicitly indicating that two images should be placed in specific locations on a page rather than indicating that the images are intended to be presented side-by-side as a before-and-after comparison.

When trying to repurpose or re-layout document content that has been defined using explicit formatting information rather than format intent information, it may be difficult to optimally present the document content on devices having drastically different display sizes, capabilities, and/or aspect ratios. For example, content in a document that was defined using explicit formatting information to fit an 8.5″×11″ printed page in portrait orientation may be difficult to present in landscape mode on a smartphone or tablet device. Other challenges might also be present when trying to present document content that has been defined using explicit formatting information rather than format intent information.

It is with respect to these considerations and others that the disclosure made herein is presented.

### SUMMARY

Technologies are described herein for inferring layout intent. Through an implementation of the technologies disclosed herein, the layout intent of a document author (which might also be referred to herein as the “expressive intent” or the “formatting intent” of an author) can be inferred from explicitly formatted document elements. An intent-based document may then be generated using the inferred layout intent for explicitly formatted document elements in a document. The intent-based document may then be utilized to effectively render the document in a manner that preserves the original layout intent of the document author. Moreover, because the intent-based document is defined in terms of layout intent, rather than through the use of explicit formatting, the document can be rendered effectively in various sizes and orientations, and on various types of devices having different screen types and aspect ratios. Moreover, in some configurations the mood and/or styling of the content elements in the document may be modified while still preserving the original formatting intent of the document author.

In order to generate an intent-based document from a document having explicitly formatted document elements, the layout type of the document is first determined in some configurations. For example, and without limitation, heuristic algorithms and/or machine learning classifiers may be utilized to determine whether the layout of the document is “paper-like” or “presentation-like.” The machine learning classifiers may be trained based upon human classification of the layouts of documents in a corpus of training documents.

Generally, paper-like document layouts are layouts that are meant to be consumed linearly in a top-to-bottom fashion (in the English language, for example). Presentation-like document layouts commonly include discrete “slides” that are meant to be shown in sequence. Presentation-like document layouts also commonly have content that is repeated from slide-to-slide in a different manner than repeated content in paper-like document layouts. Document layout types other than paper-like and presentation-like layouts might also be identified in other configurations.

Once the layout type for a document has been determined, the layout intent of explicitly formatted document elements in the document may be determined. For example, and without limitation, text may be differentiated and clustered, including the formatting properties. Additionally, frequency and/or statistical knowledge may be utilized to assign intents to different clusters. It might also be determined that explicitly formatted bold or italicized text in the document was intended to provide emphasis for the text. For instance, a document may have all of its text in italics except small chunks or words that are in non-italicized format. In this case, the italicized text may be considered non-emphasized and the less-frequent non-italicized text may be considered emphasized. Alternately, it might be determined that explicitly formatted bold or italicized text was intended to establish a section heading, a title for the document, or to specify a direct quotation.

In some configurations, the two-dimensional (“2D”) and/or three-dimensional (“3D”) spatial relationships between document elements may be utilized to infer the layout intent of the author of the document with respect to those elements or others. Likewise, the temporal relationships between document elements in a presentation-like document, for example, might be utilized to infer the layout intent of a document author with respect to those document elements or others. The layout intent of a document author with respect to various other types of explicitly formatted document elements might also be determined in other ways.

In some configurations, one or more heuristic algorithms and/or one or more machine learning classifiers determine the layout intent of explicitly formatted document elements in the document. For example, and without limitation, heuristic algorithms might examine patterns or configurations of document elements in a document to determine the inferred layout intent for explicitly formatted document elements contained therein.

The heuristic algorithms and/or the machine learning classifiers utilized to infer layout intent might be selected and/or configured based upon the determined layout type of the document containing the explicitly formatted document elements. In this way, software components utilized to infer the layout intent of explicitly formatted document elements can be customized based upon the determined layout type of the document. The machine learning classifiers utilized to determine layout intent may also be trained based upon human classification of the layout intent of explicitly formatted document elements in documents in a corpus of training documents.

In some configurations, an intent-based document is created using the inferred layout intent for some or all of the explicitly formatted document elements in a document. In one configuration, the intent-based document includes markup that defines its content in terms of the inferred layout intent of the author of the document from which it was generated. In the example given above where it is determined that the layout intent of an author of bold or italicized text is to provide emphasis to the text, for instance, the intent-based document may include the text along with associated markup indicating that the text is to be emphasized when rendered. In a similar fashion, if it is determined that the layout of an author of non-formatted text was to provide emphases, as in the example also given above, markup may be associated with the non-formatted text indicating that the text is to be emphasized when rendered. In the example given above where it is determined that the layout intent of an author of bold or italicized text is to define a section heading, the intent-based document may include the text and associated markup indicating that the text is to be utilized as a section heading when rendered. Other types of markup might also be utilized in the intent-based document in order to define document elements and their associated layout intent.

In some configurations, one or more certainty scores are also generated for each inferred layout intent. A certainty score is a measure of the certainty that the inferred layout intent for an explicitly formatted document element was the actual layout intent of the document author. The certainty scores may be utilized when rendering the intent-based document and, potentially, for other purposes. For example, and without limitation, the layout intent having the highest certainty score may be utilized to initially render a document element in an intent-based document. A user may then indicate that the layout for a particular document element is incorrect (e.g. text is shown as emphasized rather than as a section heading as intended). In this situation, the layout intent for the explicitly formatted document element having the next highest certainty score may then be utilized to render the document element. The certainty scores might also be utilized in other ways in other configurations.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a flow diagram showing a routine that illustrates aspects of one mechanism described herein for using inferred layout intent to generate an intent-based document from a document in which document elements have been defined using explicit formatting information;

FIG. 2 is a software architecture diagram showing aspects of the configuration and operation of a document layout classification service that may be utilized to classify the layout of a document to be converted to an intent-based document;

FIG. 3 is a flow diagram showing a routine that illustrates aspects of the operation of the document layout classification service for classifying the layout of a document to be converted to an intent-based document;

FIG. 4 is a software architecture diagram showing aspects of the configuration and operation of a document conversion service utilized to generate an intent-based document from a document that includes explicitly formatted document elements;

FIG. 5 is a flow diagram showing a routine that illustrates aspects of the operation of the document conversion service for generating an intent-based document from a document that includes explicitly formatted document elements;

FIG. 6 is a computer architecture diagram illustrating an illustrative computer hardware and software architecture for a computing system capable of implementing aspects of the technologies presented herein;

FIG. 7 is a diagram illustrating a distributed computing environment capable of implementing aspects of the technologies presented herein; and

FIG. 8 is a computer architecture diagram illustrating a computing device architecture capable of implementing aspects of the technologies presented herein.

### DETAILED DESCRIPTION

The following detailed description is directed to technologies for inferring layout intent. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

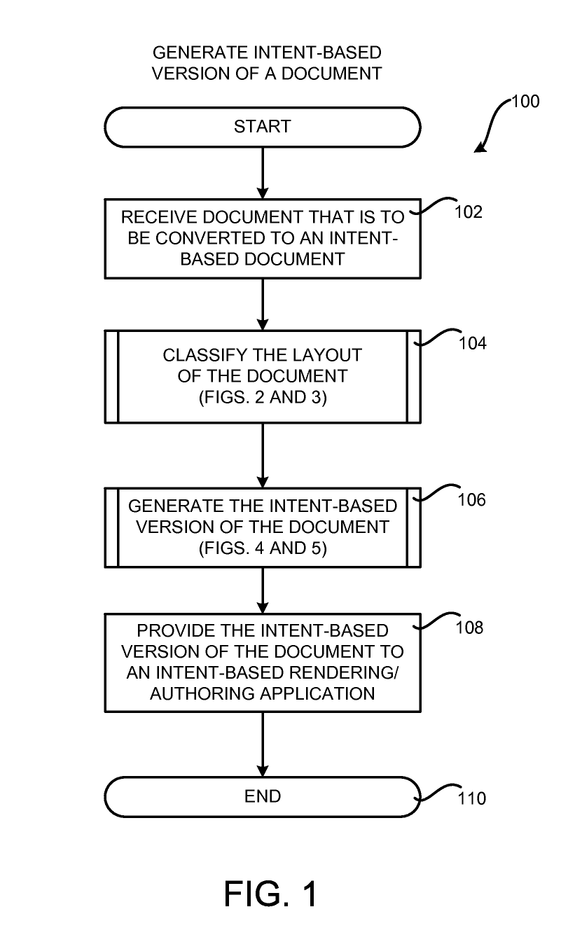

In the following detailed description, references are made to the accompanying drawings that form a part hereof, and which are shown by way of illustration specific configurations or examples. Referring now to the drawings, in which like numerals represent like elements throughout the several FIGS., aspects of various technologies for inferring layout intent will be described. In particular, FIG. 1 is flow diagram showing a routine 100 that illustrates aspects of one mechanism described herein for using inferred layout intent to generate an intent-based document from a document in which document elements have been defined using explicit formatting information.

It should be appreciated that the logical operations described herein with regard to FIG. 1 and the other FIGS. are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the FIGS. and described herein. These operations may also be performed in a different order than those described herein.

The routine 100 begins at operation 102, where a document is received that includes document elements that have been defined using explicit formatting information (which might be referred to herein as “explicitly formatted document elements”) and that is to be converted to an intent-based document. Explicitly formatted document elements are elements in a document for which the document author has explicitly specified formatting properties and/or other attributes. A document author might, for instance, define text and apply bold, italics, color, or another type of formatting to the text. As another example, a document author might specify the exact location of images in a document with respect to a related block of text.

A document containing explicitly formatted document elements might be received, for example, in response to receiving a request to open the document in an intent-based rendering/authoring application. An intent-based rendering/authoring application utilizes the formatting intent of the document author in order to render an intent-based document. An intent-based rendering/authoring application might also permit a user to author and/or modify an intent-based document and/or to perform other types of functionality with respect to intent-based documents or other document types wherein formatting is expressed using explicit formatting.

In order to open a document that includes document elements that have been defined using explicit formatting information in an intent-based rendering/authoring application, it may be necessary to convert the document into an intent-based document. As discussed briefly above, an intent-based document includes markup that defines its content in terms of the inferred layout intent of the author of the document from which it was generated rather than through the use of explicit formatting information.

The document received at operation 102 might also be received along with a request to render the document for presentation to a user. For example, and without limitation, a user may submit a request to view the document on a smartphone or tablet computing device. As discussed briefly above, content in a document that was originally defined using explicit formatting information to fit an 8.5″×11″ printed page in portrait orientation may be difficult to present in landscape mode on a smartphone or tablet device. However, because an intent-based document is defined in terms of layout intent, rather than through the use of explicit formatting, the document can be rendered effectively in various sizes and orientations, and on various types of devices having different screen types and aspect ratios. Additional details regarding this process will be provided below.

It should be appreciated that the document received at operation 102 might be a word processing document, a presentation document, a spreadsheet document, a HyperText Markup Language (“HTML”) document, a video, a Portable Document Format (“PDF”) document, or any other type of document that includes document elements that have been defined using explicit formatting information. Additionally, it should also be appreciated that the document might include some document elements that have been defined using explicit formatting information and other document elements that have been defined in terms of the author's intent. One example of this would be leveraging a heading style that defines the author's intent to use the text as a heading. In this example, document elements that have been defined using explicit formatting information might be converted using the process described below, while those document elements defined in terms of the author's intent would not be converted.

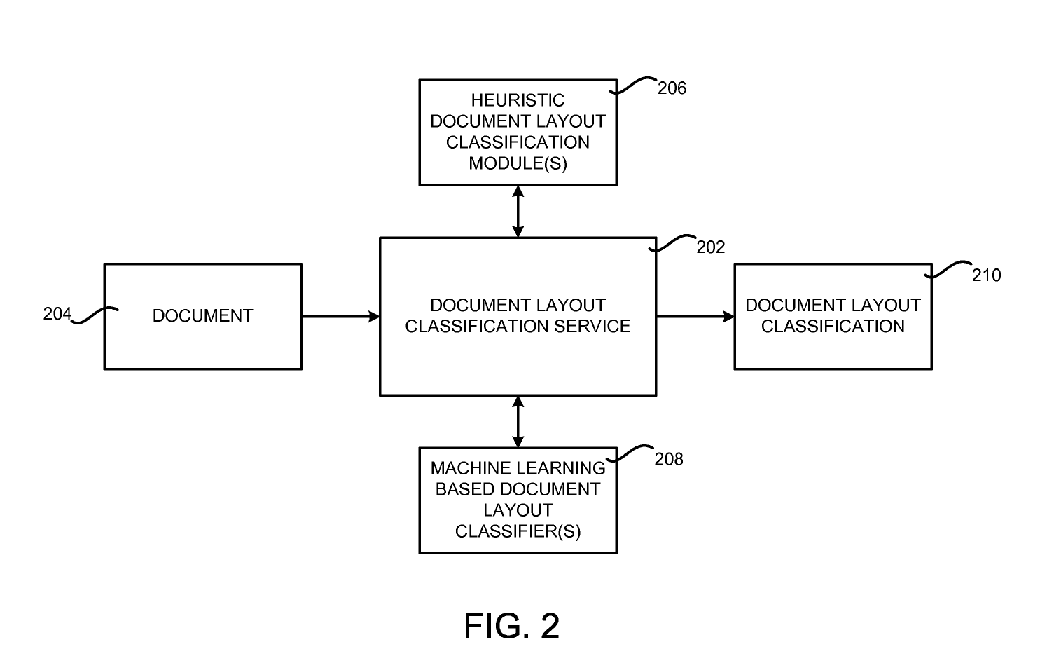

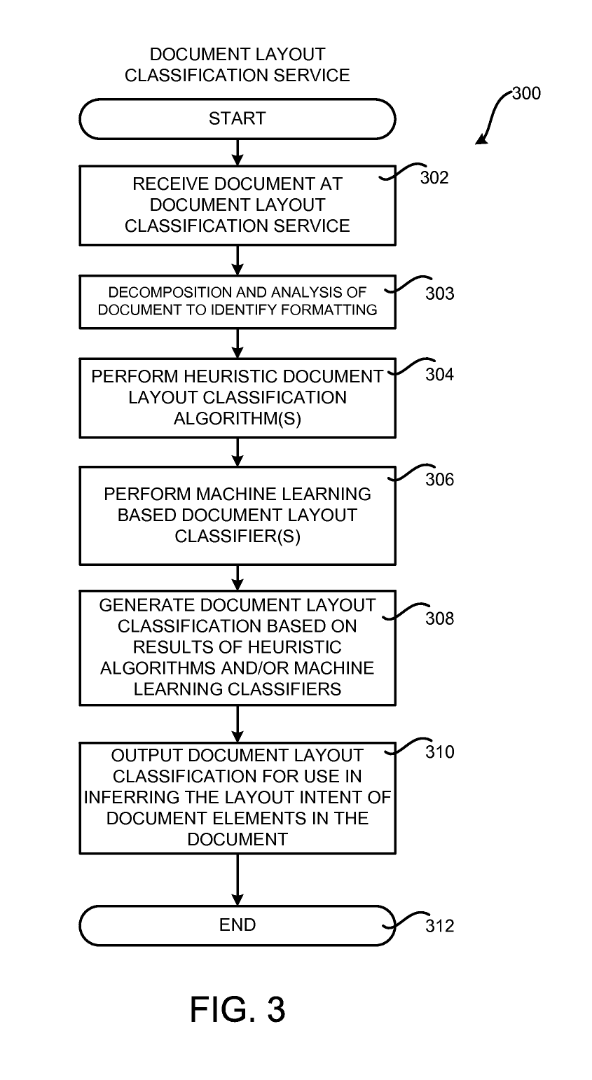

From operation 102, the routine 100 proceeds to operation 104, where the layout type of the document received at operation 102 and having explicitly formatted document elements is determined. For example, and without limitation, heuristic algorithms and/or machine learning classifiers may be utilized to determine whether the layout of a document having explicitly formatted elements is “paper-like” or “presentation-like.” As discussed briefly above, paper-like document layouts are layouts that are intended to be consumed linearly in a top-to-bottom fashion (in the English language, for example). Presentation-like document layouts commonly include discrete “slides” that are meant to be shown in sequence. Presentation-like document layouts may also have content that is repeated from slide-to-slide in a different manner than content in paper-like document layouts. Document layout types other than paper-like and presentation-like might also be identified in other configurations. Additional details regarding one mechanism disclosed herein for classifying the layout type of a document will be provided below with regard to FIGS. 2 and 3.

Once the layout type of the document received at operation 102 has been determined, the routine 100 proceeds from operation 104 to operation 106, where an intent-based version of the document is generated. In order to generate an intent-based version of a document, the layout intent of explicitly formatted document elements in the document may be determined. For example, and without limitation, it might be determined that explicitly formatted bold or italicized text in the document was intended to provide emphasis for the text. Alternately, it might be determined that explicitly formatted bold or italicized text was intended to establish a section heading or a title for the document. Similarly, the 2D and/or 3D spatial relationships between document elements may be utilized to infer the layout intent of the author of the document. Likewise, the temporal relationships between document elements in a presentation-like document, for example, might be utilized to infer the layout intent of the document author. The layout intent of a document author with respect to various other types of explicitly formatted document elements might also be determined in other ways.

As will be described in greater detail below, one or more heuristic algorithms and/or one or more machine learning classifiers may be utilized to determine the layout intent of explicitly formatted document elements in the document. For example, and without limitation, heuristic algorithms might examine patterns or configurations of document elements in a document to determine the inferred layout intent for explicitly formatted document elements contained therein. The heuristic algorithms and/or the machine learning classifiers utilized to infer layout intent might be selected and/or configured based upon the determined layout type of the document containing the explicitly formatted document elements. The machine learning classifiers utilized to determine layout intent may be trained based upon human classification of the layout intent of explicitly formatted document elements in documents in a corpus of training documents.

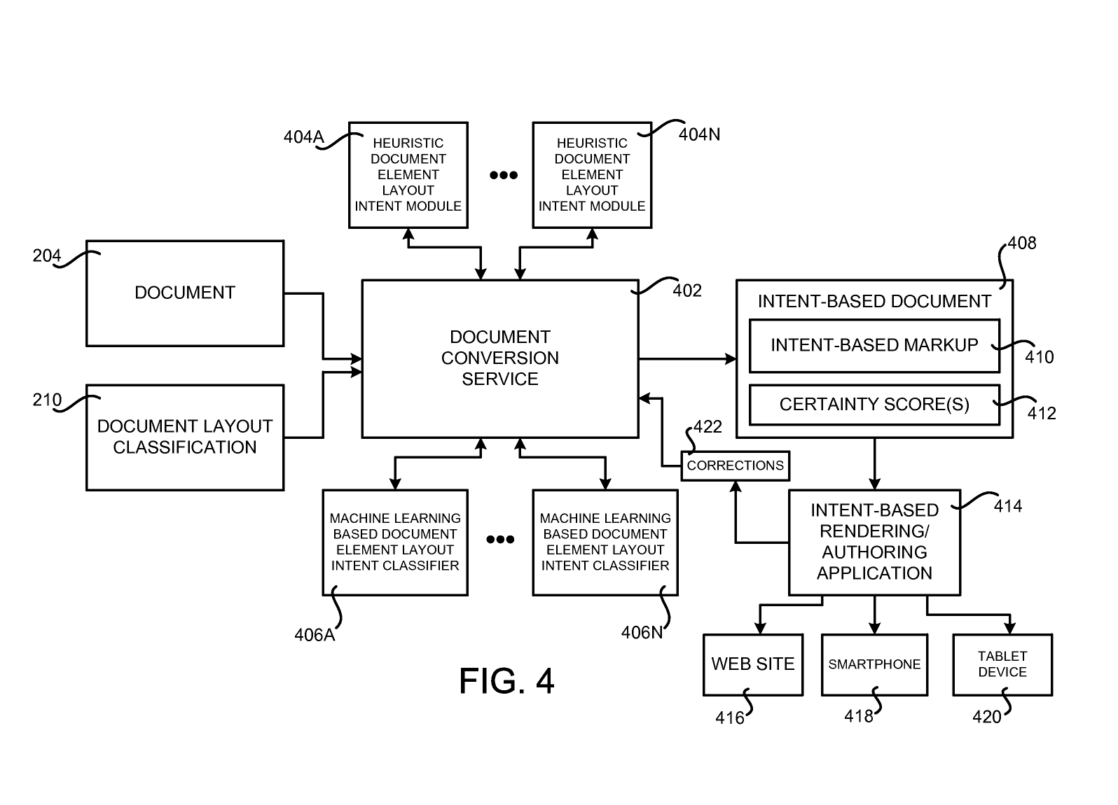

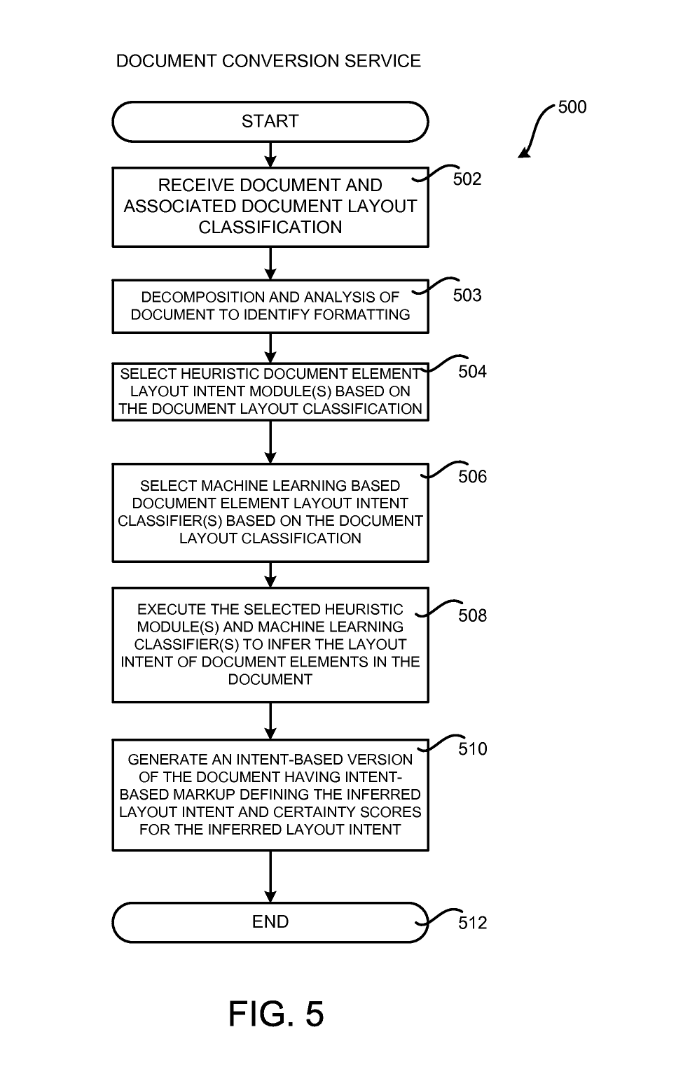

In some configurations, an intent-based document is created using the inferred layout intent for some or all of the explicitly formatted document elements in a document. In one configuration, the intent-based document includes markup that defines its content in terms of the inferred layout intent of the author of the document from which it was generated. Additionally, in some configurations, one or more certainty scores are also generated for each inferred layout intent and are included in the intent-based document. As mentioned briefly above and described in greater detail below, a certainty score defines the certainty that the inferred layout intent for an explicitly formatted document element was the actual layout intent of the document author. The certainty scores may be utilized when rendering the intent-based document and, potentially, for other purposes. Additional details regarding the mechanism described above for generating an intent-based version of a document will be provided below with reference to FIGS. 4 and 5.

From operation 106, the routine 100 proceeds to operation 108, where the intent-based document generated at operations 104 and 106 may be provided to the intent-based rendering/authoring application. As discussed briefly above, the intent-based rendering/authoring application may render the intent-based document in a manner that is appropriate for the computing device upon which it is to be presented. The rendering of the intent-based document is performed in a manner that preserves the layout intent of the document author. Additionally, the intent-based rendering/authoring application might beautify the presentation of the intent-based document also in a manner that preserves the document author's original intent. Additional details regarding this process will also be provided below. The routine 100 then proceeds from operation 108 to operation 110, where it ends.

FIG. 2 is a software architecture diagram showing aspects of the configuration and operation of a document layout classification service 202 that may be utilized to classify the layout of a document 204 to be converted to an intent-based document. As shown in FIG. 2, the document layout classification service 202 receives a document 204 that includes explicitly formatted document elements. The document layout classification service 202 may then analyze the layout of the received document 204 in order to classify its layout. In particular, a document layout classification 210 may be generated that defines the identified layout type of the document 204.

In the configuration shown in FIG. 2, the document layout classification service 202 utilizes one or more heuristic document layout classification modules 206 and, potentially, one or more machine learning based document layout classifiers 208 in order to generate the document layout classification 210. The heuristic document layout classification modules 206 are software modules that implement heuristic document layout algorithms for determining the layout type of a document. The machine learning based document layout classifiers 208 are machine learning classifiers that have been trained to identify the layout type of a document 204. The machine learning based document layout classifiers 208 may be trained based upon human classification of the layouts of documents in a corpus of training documents (not shown in FIG. 2).

In one particular configuration, the heuristic document layout classification modules 206 and the machine learning based document layout classifiers 208 are configured to classify a document 204 as having a paper-like layout or a presentation-like layout. As discussed above, paper-like document layouts are layouts that are meant to be consumed linearly in a top-to-bottom fashion (in the English language, for example). As also discussed above, presentation-like document layouts commonly include discrete “slides” that are meant to be shown in sequence. It should be appreciated that the heuristic document layout classification modules 206 and the machine learning based document layout classifiers 208 might also be configured to identify document layout types other than paper-like and presentation-like layouts in other configurations.

It should also be appreciated that, in some configurations, no assumptions are made regarding the layout of a document 204 based upon the file type of the document. For example, no assumption will be made that a word processing document 204 has a paper-like layout type. Similarly, a presentation document 204 will also not automatically be assumed to have a presentation-type layout. This is because word processing documents might have layouts that are presentation-like. Similarly, presentation documents might have paper-like layouts. Consequently, the actual layout of the document 204, and not the file type of the document 204, is utilized in various configurations to determine the document layout classification 210. It should be appreciated, however, that the document layout classification service 202 might give some weight to the file type of the document 204 during the determination of the document layout classification 210.

In the example shown in FIG. 2, the document layout classification service 202 is implemented as a Web service. In this implementation, the document layout classification service 202 might expose various types of Web service application programming interfaces (“APIs”) in order to access aspects of its functionality. It should be appreciated, however, that this configuration is merely illustrative and that the functionality implemented by the document layout classification service 202 might be provided in other ways. For example, and without limitation, this functionality might be included directly in an intent-based rendering/authoring application that executes natively on a computing device, such as a smartphone, tablet, desktop or laptop computer. Alternately, this functionality might be provided through an intent-based rendering/authoring application that is provided as a Web-based application and accessed through a Web browser or other suitable application. This functionality might also be provided in other ways in other configurations.

In the example configuration shown in FIG. 2, the heuristic document layout classification modules 206 and the machine learning based document layout classifiers 208 are shown external to the document layout classification service 202. It should be appreciated, however, that these components might be integrated with the document layout classification service 202 in other configurations. Additionally, it should be appreciated that mechanisms other than heuristics and machine learning might be utilized in other configurations to classify the layout of a document 204.

As will be described in greater detail below, the determined document layout classification 210 for the document 204 may be utilized to customize the mechanism disclosed herein for converting the document 204 to an intent-based document. Additional details regarding this aspect will be provided below with regard to FIGS. 3 and 4.

FIG. 3 is a flow diagram showing a routine 300 that illustrates aspects of the operation of the document layout classification service 202 for classifying the layout of a document 204 that contains explicitly formatted document elements. The routine 300 begins at operation 302, where a document 204 that includes explicitly formatted document elements is received at the document layout classification service 202. As discussed above, the document 204 might be provided to the document layout classification service 202 in response to a request to render the document 204 in an intent-based rendering/authoring application or in response to other types of stimuli. From operation 302, the routine 300 proceeds to operation 303.

At operation 303, decomposition and analysis of the document is performed to identify the formatting in the document. For text, this would include things like the typeface, point size, weight, and/or color of the text. Some of these data points might also be calculated from the original document 204. For example, HTML web documents may leverage nested CSS styles, which need to be calculated to determine the actual color or typeface, for instance. The HTML structures may also be analyzed to understand relative positioning of an image with relation to text.

The routine 300 then proceeds from operation 303 to operation 304, where the document layout classification service 202 executes the heuristic document layout classification modules 206 in order to perform one or more heuristics-based document layout classification algorithms. As discussed above, the heuristic document layout classification modules 206 utilize heuristics in an attempt to classify the layout of the document 204. For example, and without limitation, various heuristics might be utilized to determine if the layout of the document 204 is paper-like or presentation-like.

From operation 304, the routine 300 proceeds to operation 306, where the document layout classification service 202 may execute the machine learning based document layout classifiers 208 in order to classify the layout type of the document 204. As discussed above, the machine learning based document layout classifiers 208 may be trained based upon human classification of the layouts of documents in a corpus of training documents. Based upon the results of this training, the machine learning based document layout classifiers 208 may be able to classify the layout of the document 204 as being either paper-like or presentation-like. As discussed above, the machine learning based document layout classifiers 208 might also classify the layout of the document 204 into another type of classification in other configurations.

From operation 306, the routine 300 proceeds to operation 308, where the document layout classification service 202 generates the document layout classification 210 based upon the results of the processing performed by the heuristic document layout classification modules 206 and/or the machine learning based document layout classifiers 208. As mentioned above, the document layout classification 210 includes data indicating the layout type determined for the document 204. For example, and without limitation, the document layout classification 210 might indicate whether the document 204 has a paper-like layout or a presentation-like layout. Other layout types might also be indicated in other configurations.

From operation 308, the routine 300 proceeds to operation 310 where the document layout classification service 202 outputs the document layout classification 210 for the document 204. For example, and without limitation, the document layout classification service 202 may output the document layout classification 210 to a document conversion service for use in converting the document 204 to an intent-based document. Additional details regarding the use of the document layout classification 210 during the conversion of the document 204 will be described below with regard to FIGS. 4 and 5. From operation 310, the routine 300 proceeds to operation 312, where it ends.

It should be appreciated that the mechanisms described above for classifying the layout of a document 204 are merely illustrative and that other mechanisms might also be utilized. For example, and without limitation, in some configurations various cultural factors such as whether a document reads right-to-left or left-to-right might be considered when classifying the layout type of a document 204. It should also be appreciated that the layout type of certain types of documents 204 might be determined without actually rendering the document 204. For other types of documents 204, such as PDF documents, the document 204 may be rendered in memory in order to classify the layout type of the document.

FIG. 4 is a software architecture diagram showing aspects of the configuration and operation of a document conversion service 402 utilized to generate an intent-based document 408 from a document 204 that includes explicitly formatted document elements. As shown in FIG. 4, the document conversion service 402 provides functionality in one configuration for converting a document 204 containing explicitly formatted document elements into an intent-based document 408.

In the configuration shown in FIG. 4, the document conversion service 402 is implemented as a Web service. In this implementation, the document conversion service 402 might expose various types of Web service APIs in order to access aspects of its functionality. It should be appreciated, however, that this configuration is merely illustrative and that the functionality implemented by the document conversion service 402 might be provided in other ways. For example, and without limitation, the disclosed functionality might be included directly in an intent-based rendering/authoring application that executes natively on a computing device, such as a smartphone, tablet, desktop or laptop computer. Alternately, this functionality might be provided through an intent-based rendering/authoring application that is provided as a Web-based application and accessed through a Web browser or other suitable application. This functionality might also be provided in other ways in other configurations.

As shown in FIG. 4, the document conversion service 402 takes as input a document 204 that includes explicitly formatted document elements and a document layout classification 210 for the document 204. The document layout classification 210 for the document 204 might be generated in the manner described above with regard to FIGS. 2 and 3. As mentioned above, other mechanisms might also be utilized to classify the layout of a document 204 that contains explicitly formatted document elements.

In one configuration, the document conversion service 402 utilizes one or more heuristic document element layout intent modules 404A-404N (which might be referred to herein collectively as the “modules 404”) in order to determine the layout intent associated with explicitly formatted document elements in the document 204. The modules 404 might implement heuristic algorithms designed to infer a layout intent from the explicitly formatted document elements in a document 204. For example, and without limitation, the modules 404 might examine patterns or configurations of document elements in a document 204 to determine the inferred layout intent for explicitly formatted document elements contained therein. Similarly, these modules might analyze document elements with reference to their location within a document 402, their spatial and temporal relationships with other document elements, their location in a document, and/or other relationships between similar and dissimilar document elements in order to infer layout intent.

In some implementations, the document conversion service 402 selects and/or configures the modules 404 based upon the document layout classification 210. For example, and without limitation, the document conversion service 402 might select and/or configure the modules 404 for determining the layout intent of explicitly formatted document elements in a document having a paper-like layout. Similarly, the document conversion service 402 might select and/or configure the modules 404 for determining the layout intent of explicitly formatted document elements in a document having a presentation-like layout. In this way, the operation of the modules 404 can be configured to optimally determine the layout intent of document elements in documents 204 that have different layout types.

Some of the modules 404 might be configured to infer layout intent based upon the formatting of titles within a document 204. For example, in a document 204 with a presentation-like layout, if several slides have identical (or nearly identical with a white list of differences) titles, then all of the slides may be inferred to be a part of the same section with a single title. In another example, if images or text are repeated on several contiguous slides in a document 204 having a presentation-like layout, that material may be inferred to be navigational or sidebar content and may only be included once in the intent-based document 408.

In a document 204 having a paper-like layout, if a short run of text is different than the surrounding text, including white space, and is not in a format that matches the titles and/or headings in the document 204, then the text may be inferred to be a pull-quote. As known to those skilled in the art, a pull-quote is a quote from the same page that is typically emphasized in some manner. If the text is surrounded with quotation marks, then the certainty score 412 for this inferred layout intent will increase. The certainty score 412 for this inferred layout intent will also increase if the formatting of the text matches another identified pull-quote that is surrounded with quotation marks.

It should be appreciated that the illustrative heuristic algorithms described above are merely illustrative. Other types of heuristic algorithms might also be implemented by the modules 404 for inferring the layout intent of other types of explicitly formatted document elements in other configurations.

As shown in FIG. 4, the document conversion service 402 might also, or alternately, utilize one or more machine learning based document element layout intent classifiers 406A-406N (which might be referred to collectively as “the classifiers 406”). The classifiers 406 are machine learning classifiers that have been trained to recognize the intent of an author with respect to explicitly formatted document elements in a document 204. In order to provide this functionality, the classifiers 406 may be trained based upon human classification of the layout intent of explicitly formatted document elements in documents in a corpus of training documents (not shown in FIG. 4).

In some implementations, the document conversion service 402 selects and/or configures the classifiers 406 based upon the document layout classification 210. For example, and without limitation, the document conversion service 402 might select and/or configure the classifiers 406 for determining the layout intent of explicitly formatted document elements in a document having a paper-like layout. Similarly, the document conversion service 402 might select and/or configure the classifiers 406 for determining the layout intent of explicitly formatted document elements in a document having a presentation-like layout. In this way, the operation of the classifiers 406 can be configured to optimally determine the layout intent of document elements in documents 204 that have different layout types.

The modules 404 and/or the classifiers 406 are configured in various embodiments to infer that a document author intended for one or more explicitly formatted document elements to be emphasized. For example, certain text in bold or italics may be surrounded by other text in a paragraph that is not bolded or emphasized. In this example, the modules 404 or classifiers 406 might infer that the author intended the text to be emphasized. Special use of italics might also be inferred to identify a reference work, names of ships, new terms, user mentions, foreign words or symbols (e.g. Greek or Latin symbols), algebraic symbols, and/or mathematical constants. Text might also be inferred to be a pull-quote as described in the example set forth above. As also discussed above, the lack of explicit formatting in a document 204 might also be a signal for emphasis. This may be determined per relative entropy in formatting clusters in some configurations. Each formatting cluster is a distinct set of all properties determining text-span formatting. The clusters may be calculated from the CSS associated with a document 204 or directly from the contents of the document 204.

The modules 404 and/or the classifiers 406 might also be configured to infer that text defines a title and/or a hierarchy from the size, indentation, spacing, formatting and/or other attributes of text in a document 204. Examples of hierarchies might include, but are not limited to, chapters, sub-chapters, sub-sub-chapters, etc. In this way the intent of a document author to create an outline or other type of structure can be inferred from explicitly formatted text and utilized to create an intent-based document 408 that defines the author's intent.

The modules 404 and/or the classifiers 406 might also be configured to evaluate the 2D or 3D space or non-space in a document 204 to infer an author's expressive intent. Document elements that overlay one another might also be analyzed to determine the author's expressive intent. The temporal relationships among document elements might also be analyzed in a similar manner to determine an associated expressive intent. For example, in a document with a presentation-like layout, elements might build up on slides over time. In this example, the temporal sequencing of document elements might be relevant information from which expressive intent can be inferred. In this regard, it might be necessary to render some document types in-memory in order to identify the spatial and/or temporal relationships among document elements.

In the example configuration shown in FIG. 4, the modules 404 and the classifiers 406 are shown external to the document conversion service 402. It should be appreciated, however, that these components might be integrated with the document conversion service 402 in other configurations. Additionally, it should be appreciated that mechanisms other than heuristics and machine learning might be utilized in other configurations to classify the layout intent for explicitly formatted document elements in a document 204.

As also shown in FIG. 4, the document conversion service 402 may utilize the output of the modules 404 and the classifiers 406 in order to generate an intent-based document 408. The intent-based document 408 includes the content from the document 204 (e.g. text, images, videos, etc.) or a reference to the location of the content, along with data describing the inferred layout intent for some or all of the explicitly formatted document elements in the document 204. For example, in one configuration the intent-based document 408 includes markup 410 that defines document elements contained therein in terms of the inferred layout intent of the author of the document 204 from which it was generated. As a specific example, if the modules 404 or the classifiers 406 determine that the layout intent of an author of bold or italicized text in the document 204 is to provide emphasis to the text, the intent-based document 410 includes markup 410 that identifies the text and that indicates that the text is to be emphasized when rendered. The manner in which the text is actually emphasized may be determined at render-time based upon the orientation in which the intent-based document 408 is to be rendered, the capabilities of the target device and/or other considerations or factors. The manner in which the text is presented might also be modified in order to augment or modify the style and/or aesthetics of the document 204.

As another example, if the modules 404 or the classifiers 406 determine that the layout intent of bold or italicized text is to define a section heading, the intent-based document 408 may include markup 410 defining the text and indicating that the text is to be utilized as a section heading when rendered. The manner in which the section heading is actually rendered may be determined at render-time based upon the orientation in which the intent-based document 408 is to be rendered, the capabilities of the target device and/or other considerations or factors. Other types of markup 410 might also be specified in the intent-based document 408 in order to define other types of document elements and their associated layout intent.

As shown in FIG. 4, the document conversion service 402 may provide the intent-based document 408 to the intent-based rendering/authoring application 414 once the conversion process is completed. In turn, the intent-based rendering/authoring application 414 may render the intent-based document 408. As discussed briefly above, the intent-based rendering/authoring application 414 may utilize the intent-based markup 410 in order to render the intent-based document 408 in a manner that is appropriate for the target rendering platform. For example, and without limitation, the intent-based rendering/authoring application 414 might render the intent-based document for consumption as a Web page on a Web site 416, for consumption on a smartphone 418 in either portrait or landscape orientation, or for consumption on a tablet device 420 in either portrait or landscape orientation.

In some configurations, the document conversion service 402 is also configured to generate one or more certainty scores 412 for each inferred layout intent. As mentioned briefly above, a certainty score is a measure of the certainty that the inferred layout intent for an explicitly formatted document element was the actual layout intent of the document author. The certainty scores 412 might be a number between zero and one, for example, where zero is the lowest probability that the inferred layout intent is correct and one is the highest.

It should be appreciated that confidence score 412 for one document element might be influenced by other document elements in some configurations. For example, a confidence score 412 might be computed for a first document element. But, if other similar elements are found in a document 204, the configuration of those elements and their associated confidence scores 412 might change the confidence score 412 computed for the first document element. In some configurations, the semantic meaning of content in a document 402 might also influence the confidence scores 412.

The certainty scores 412 may be utilized by an intent-based rendering/authoring application 414 when rendering the intent-based document 408 and, potentially, for other purposes. For example, and without limitation, the intent-based rendering/authoring application 414 may utilize the layout intent having the highest associated certainty score 412 in order to initially render a document element in an intent-based document 408. A user may then indicate that the layout for a particular document element is incorrect (e.g. text is shown as emphasized rather than as a section heading as intended). In this situation, the intent-based rendering/authoring application 414 may use the layout intent for the explicitly formatted document element having the next highest certainty score 412 in order to re-render the document element. Alternately, the most likely alternate options might be shown to the user by choosing several of the next highest scores. The certainty scores 412 might also be utilized by the intent-based rendering/authoring application 414 in other ways in other configurations.

In another configuration, the intent-based rendering/authoring application 414 might also provide any corrections 422 made to the inferred layout intent to the document conversion service 402 for use in optimizing aspects of its operation. For example, if a user indicates that a particular inferred layout intent for a document element in an intent-based document was incorrect, this information may be provided to the document conversion service 402 and utilized to improve the performance of the document conversion service 402 when inferring the layout intent of the same or similar document elements during future conversions.

FIG. 5 is a flow diagram showing a routine 500 that illustrates aspects of the operation of the document conversion service 402 for generating an intent-based document 408 from a document 204 that includes explicitly formatted document elements. The routine 500 begins at operation 502, where the document conversion service 402 receives a document 204 and an associated document layout classification 210. The routine 500 then proceeds from operation 502 to operation 503, where decomposition and analysis of the document is performed to identify the formatting in the document in a similar manner to that described above with regard to operation 303. The routine 500 then proceeds to operation 504, where the document conversion service selects and/or configures the modules 404 based upon the layout type specified in the document layout classification 210. As discussed above, the modules 404 might be selected and/or configured for optimal operation with a document 204 having a layout type of the type specified in the document layout classification 210.

From operation 504, the routine 500 proceeds to operation 506, where the document conversion service 402 selects and/or configures the classifiers 406 based upon the layout type specified in the document layout classification 210. As discussed above, the classifiers 406 might also be selected and/or configured for optimal operation with a document 204 having a layout type of the type specified in the document layout classification 210.

From operation 506, the routine 500 proceeds to operation 508, where the modules 404 and/or the classifiers 406 are executed. As discussed above, the modules 404 and the classifiers 406 operate to infer the layout intent for explicitly formatted document elements in the document 204. The modules 404 might utilize heuristic algorithms to infer the layout intent for document elements in the document 204, while the classifiers 406 may utilize machine learning techniques. As also mentioned above, the modules 404 and the classifiers 406 might also generate one or more certainty scores 412 for each inferred layout intent.

From operation 508, the routine 500 proceeds to operation 510, where the document conversion service 402 generates the intent-based document 408 based upon the results of the execution of the modules 404 and/or the classifiers 406. As discussed above, the intent-based document 408 includes intent-based markup 410 that defines document elements along with the inferred layout intent, if any, associated with the document elements. The intent-based document 408 might also include the certainty scores 412 corresponding to each inferred layout intent. As discussed above, the document conversion service 402 might also provide the intent-based document 408 to the intent-based rendering/authoring application 414 or another software component for rendering and/or modification. From operation 510, the routine 500 proceeds to operation 512, where it ends.

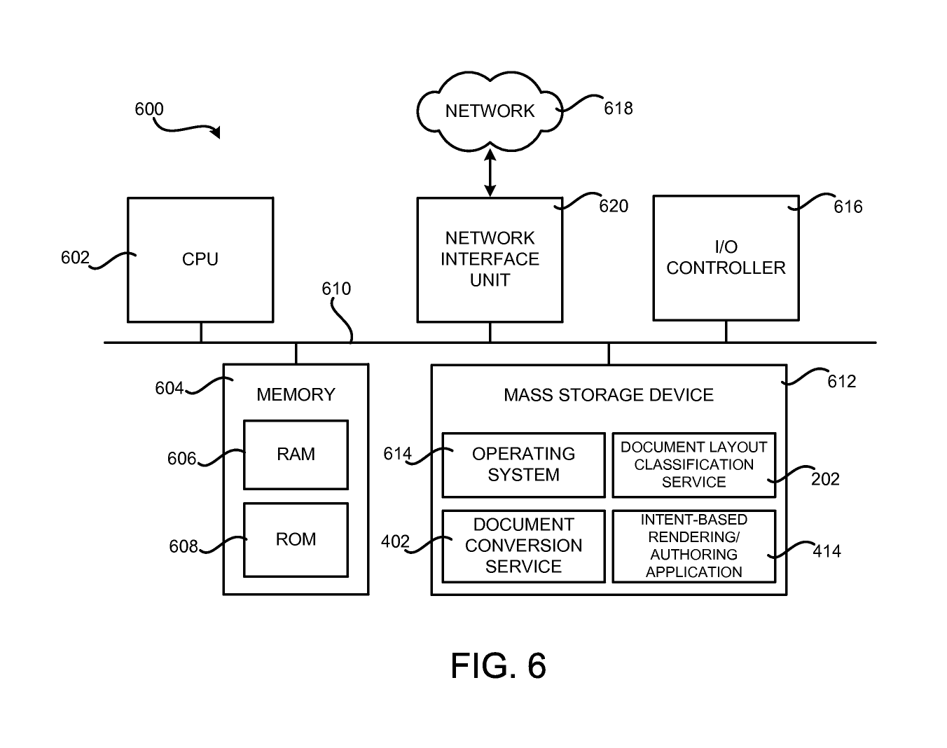

FIG. 6 is a computer architecture diagram that shows an architecture for a computer 600 capable of executing the software components described herein for inferring layout intent. The architecture illustrated in FIG. 6 is an architecture for a server computer, mobile phone, an e-reader, a smart phone, a desktop computer, a netbook computer, a tablet computer, a laptop computer, or another type of computing device suitable for executing the software components presented herein. In this regard, it should be appreciated that the computer 600 shown in FIG. 6 may be utilized to implement a computing device capable of executing any of the software components presented herein.

The computer 600 illustrated in FIG. 6 includes a central processing unit 602 (“CPU”), a system memory 604, including a random access memory 606 (“RAM”) and a read-only memory (“ROM”) 608, and a system bus 610 that couples the memory 604 to the CPU 602. A basic input/output system containing the basic routines that help to transfer information between elements within the computer 600, such as during startup, is stored in the ROM 608. The computer 600 further includes a mass storage device 612 for storing the operating system 614 and one or more application programs including, but not limited to, the document classification layout service 202, the document conversion service 402, and/or the intent-based rendering/authoring application 414. Although not shown in FIG. 6, the mass storage device 612 can also be configured to store the document 204, the intent-based document 408, and/or other data.

The mass storage device 612 is connected to the CPU 602 through a mass storage controller (not shown) connected to the bus 610. The mass storage device 612 and its associated computer-readable media provide non-volatile storage for the computer 600. Although the description of computer-readable media contained herein refers to a mass storage device, such as a hard disk or CD-ROM drive, it should be appreciated by those skilled in the art that computer-readable media can be any available computer storage media or communication media that can be accessed by the computer 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 600. For purposes of the claims, the phrase “computer storage medium,” and variations thereof, does not include waves or signals per se and/or communication media.

According to various configurations, the computer 600 may operate in a networked environment using logical connections to remote computers through a network such as the network 618. The computer 600 may connect to the network 618 through a network interface unit 620 connected to the bus 610. It should be appreciated that the network interface unit 620 also may be utilized to connect to other types of networks and remote computer systems. The computer 600 also may include an input/output controller 616 for receiving and processing input from a number of other devices, including a keyboard, mouse, or electronic stylus (not shown in FIG. 6). Similarly, the input/output controller 616 may provide output to a display screen, a printer, or other type of output device (also not shown in FIG. 6).

It should be appreciated that the software components described herein may, when loaded into the CPU 602 and executed, transform the CPU 602 and the overall computer 600 from a general-purpose computing system into a special-purpose computing system customized to facilitate the functionality presented herein. The CPU 602 may be constructed from any number of transistors or other discrete circuit elements, which may individually or collectively assume any number of states. More specifically, the CPU 602 may operate as a finite-state machine, in response to executable instructions contained within the software modules disclosed herein. These computer-executable instructions may transform the CPU 602 by specifying how the CPU 602 transitions between states, thereby transforming the transistors or other discrete hardware elements constituting the CPU 602.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For instance, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 600 in order to store and execute the software components presented herein. It also should be appreciated that the computer 600 may include other types of computing devices, including hand-held computers, embedded computer systems, mobile devices such as smartphones and tables, and other types of computing devices known to those skilled in the art. It is also contemplated that the computer 600 may not include all of the components shown in FIG. 6, may include other components that are not explicitly shown in FIG. 6, or may utilize an architecture completely different than that shown in FIG. 6.

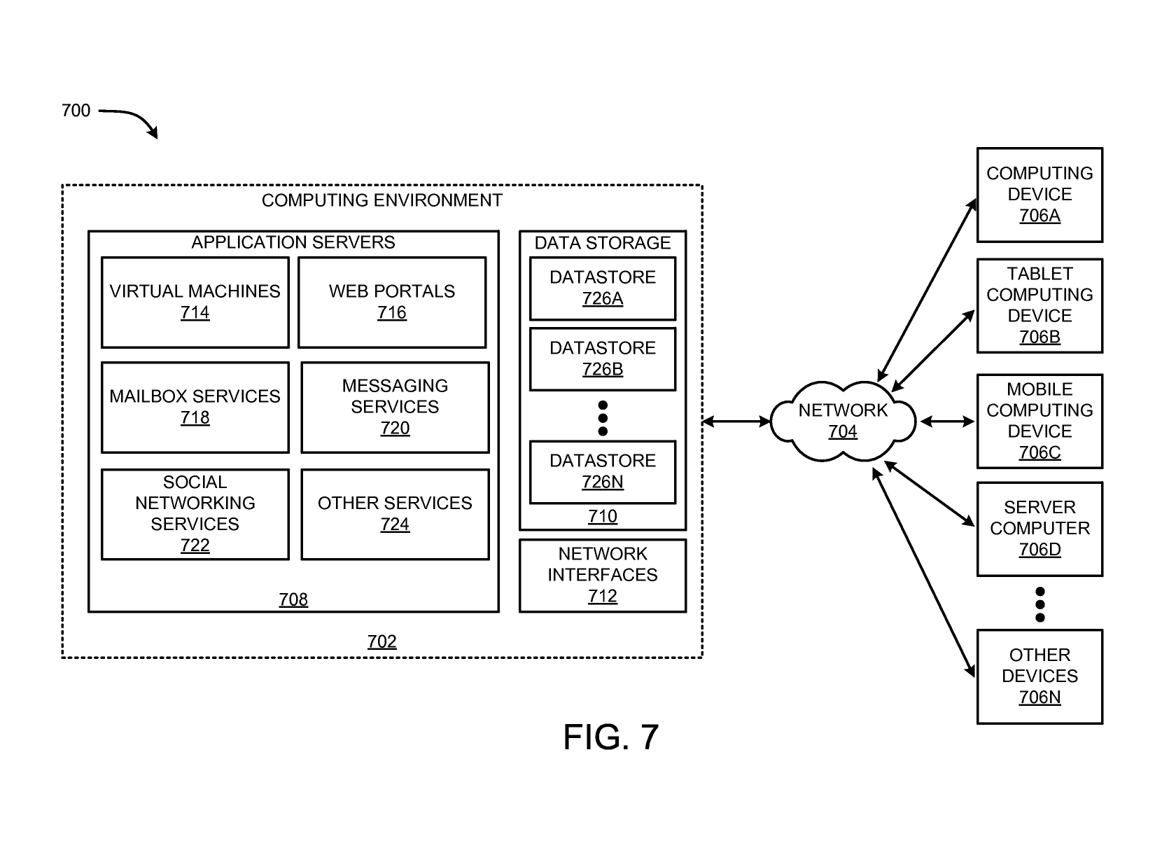

FIG. 7 illustrates an illustrative distributed computing environment 700 capable of executing the software components described herein for inferring layout intent. Thus, the distributed computing environment 700 illustrated in FIG. 7 can be used to provide the functionality described herein with respect to the document layout classification service 202, the document conversion service 402, and/or any of the other software components described herein.

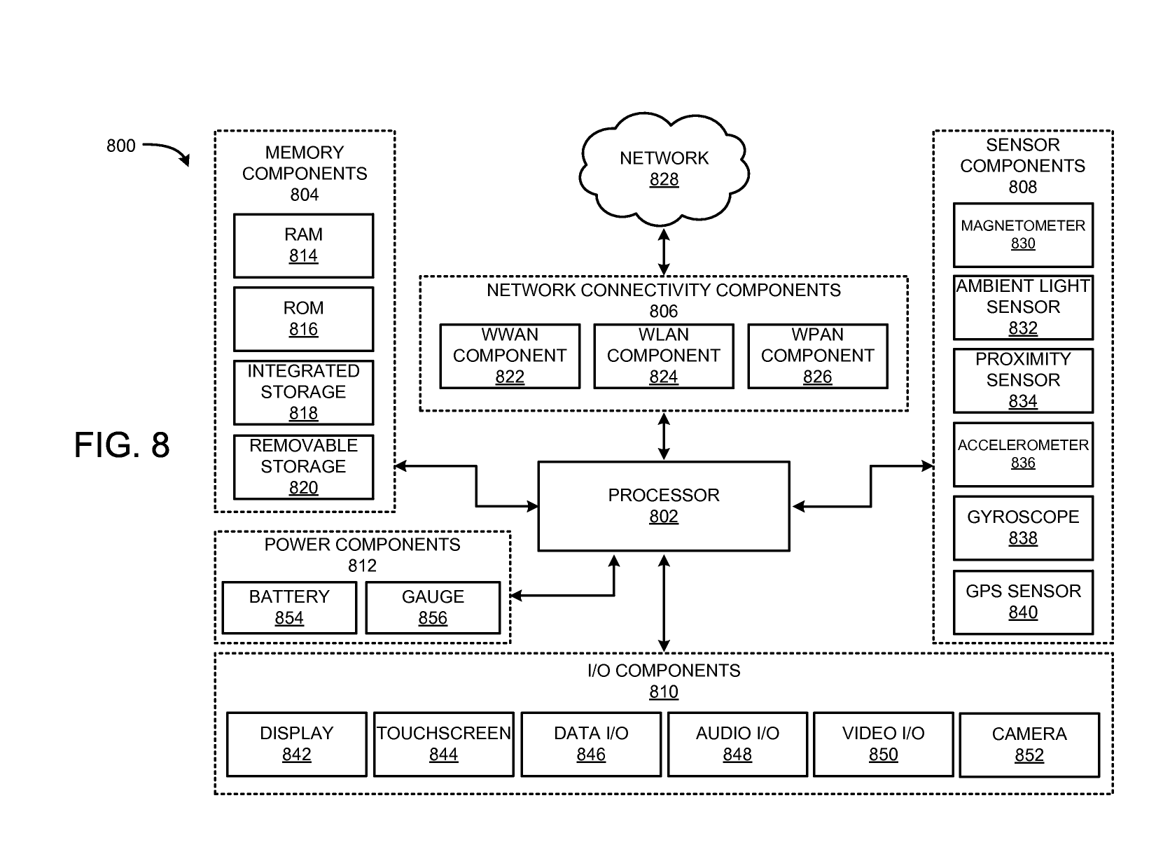

According to various implementations, the distributed computing environment 700 includes a computing environment 702 operating on, in communication with, or as part of the network 704. One or more client devices 706A-706N (hereinafter referred to collectively and/or generically as “clients 706”) can communicate with the computing environment 702 via the network 704 and/or other connections (not illustrated in FIG. 7). In the illustrated configuration, the clients 706 include a computing device 706A such as a laptop computer, a desktop computer, or other computing device; a slate or tablet computing device (“tablet computing device”) 706B; a mobile computing device 706C such as a mobile telephone, a smart phone, or other mobile computing device; a server computer 706D; and/or other devices 706N. It should be understood that any number of clients 706 can communicate with the computing environment 702. Two example computing architectures for the clients 706 are illustrated and described herein with reference to FIGS. 6 and 8. It should be understood that the illustrated clients 706 and computing architectures illustrated and described herein are illustrative, and should not be construed as being limited in any way.

In the illustrated configuration, the computing environment 702 includes application servers 708, data storage 710, and one or more network interfaces 712. According to various implementations, the functionality of the application servers 708 can be provided by one or more server computers that are executing as part of, or in communication with, the network 704. The application servers 708 can host various services, virtual machines, portals, and/or other resources. In the illustrated configuration, the application servers 708 host one or more virtual machines 714 for hosting applications or other functionality. According to various implementations, the virtual machines 714 host one or more applications and/or software modules, such as the to the document layout classification service 202 and the document conversion service 402. It should be understood that this configuration is illustrative, and should not be construed as being limiting in any way. The application servers 708 might also host or provide access to one or more Web portals, link pages, Web sites, and/or other information (“Web portals”) 716.

According to various implementations, the application servers 708 also include one or more mailbox services 718 and one or more messaging services 720. The mailbox services 718 can include electronic mail (“email”) services. The mailbox services 718 also can include various personal information management (“PIM”) services including, but not limited to, calendar services, contact management services, collaboration services, and/or other services. The messaging services 720 can include, but are not limited to, instant messaging (“IM”) services, chat services, forum services, and/or other communication services.

The application servers 708 also can include one or more social networking services 722. The social networking services 722 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 722 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 722 are provided by other services, sites, and/or providers that may or may not explicitly be known as social networking providers. For example, some web sites allow users to interact with one another via email, chat services, and/or other means during various activities and/or contexts such as reading published articles, commenting on goods or services, publishing, collaboration, gaming, and the like. Other services are possible and are contemplated.

The social networking services 722 also can include commenting, blogging, and/or microblogging services. Examples of such services include, but are not limited to, the YELP commenting service, the KUDZU review service, the YAMMER enterprise microblogging service, the TWITTER messaging service, the GOOGLE BUZZ service, and/or other services. It should be appreciated that the above lists of services are not exhaustive and that numerous additional and/or alternative social networking services 722 are not mentioned herein for the sake of brevity. As such, the configurations described above are illustrative, and should not be construed as being limited in any way.

As shown in FIG. 7, the application servers 708 also can host other services, applications, portals, and/or other resources (“other resources”) 724. The other resources 724 can include, but are not limited to, the to the document layout classification service 202, the document conversion service 402, and/or any of the other software components described herein. It thus can be appreciated that the computing environment 702 can provide integration of the concepts and technologies disclosed herein provided herein for inferring layout intent with various mailbox, messaging, social networking, productivity and/or other services or resources. For example, the concepts and technologies disclosed herein might be utilized to provide a desktop or mobile Web site for converting a document 204 to an intent-based document 408 and for viewing and, potentially, editing the intent-based document 408. Using the technologies described herein, a document 204 that includes explicitly formatted elements can be presented on the various client devices 706 in a manner that is appropriate for the screen, orientation, and/or other capabilities of the device. As a specific example, the functionality disclosed herein might be utilized in conjunction with the provision of a Web-based word processing application, a Web-based presentation application, or in conjunction with another type of Web-based content consumption or creation application.

As mentioned above, the computing environment 702 can include data storage 710. According to various implementations, the functionality of the data storage 710 is provided by one or more databases operating on, or in communication with, the network 704. The functionality of the data storage 710 also can be provided by one or more server computers configured to host data for the computing environment 702. The data storage 710 can include, host, or provide one or more real or virtual datastores 726A-726N (hereinafter referred to collectively and/or generically as “datastores 726”). The datastores 726 are configured to host data used or created by the application servers 708 and/or other data. For example, the datastores 726 may be utilized to store the document 204, the intent-based document 408, and any associated content.

The computing environment 702 can communicate with, or be accessed by, the network interfaces 712. The network interfaces 712 can include various types of network hardware and software for supporting communications between two or more computing devices including, but not limited to, the clients 706 and the application servers 708. It should be appreciated that the network interfaces 712 also may be utilized to connect to other types of networks and/or computer systems.

It should be understood that the distributed computing environment 700 described herein can implement any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the clients 706. It should be understood that the clients 706 can include real or virtual machines including, but not limited to, server computers, web servers, personal computers, mobile computing devices, smart phones, and/or other devices. As such, various implementations of the concepts and technologies disclosed herein enable any device configured to access the distributed computing environment 700 to utilize the functionality described herein for inferred layout intent.

Turning now to FIG. 8, an illustrative computing device architecture 800 for a computing device that is capable of executing various software components described herein for inferring layout intent. The computing device architecture 800 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like. Moreover, the computing device architecture 800 is applicable to any of the clients 706 shown in FIG. 7. Furthermore, aspects of the computing device architecture 800 may be applicable to traditional desktop computers, portable computers (e.g., laptops, notebooks, ultra-portables, and netbooks), server computers, and other computer systems, such as described herein with reference to FIG. 6. For example, the single touch and multi-touch aspects disclosed herein below may be applied to desktop computers that utilize a touchscreen or some other touch-enabled device, such as a touch-enabled track pad or touch-enabled mouse.

The computing device architecture 800 illustrated in FIG. 8 includes a processor 802, memory components 804, network connectivity components 806, sensor components 808, input/output components 810, and power components 812. In the illustrated configuration, the processor 802 is in communication with the memory components 804, the network connectivity components 806, the sensor components 808, the input/output (“I/O”) components 810, and the power components 812. Although no connections are shown between the individual components illustrated in FIG. 8, the components can interact to carry out device functions. In some configurations, the components are arranged so as to communicate via one or more busses (not shown).

The processor 802 includes a central processing unit (“CPU”) configured to process data, execute computer-executable instructions of one or more application programs, and communicate with other components of the computing device architecture 800 in order to perform various functionality described herein. The processor 802 may be utilized to execute aspects of the software components presented herein and, particularly, those that utilize, at least in part, a touch-enabled input.

In some configurations, the processor 802 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720P, 1080P, 4K, and greater), video games, 3D modeling applications, and the like. In some configurations, the processor 802 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some configurations, the processor 802 is, or is included in, a system-on-chip (“SoC”) along with one or more of the other components described herein below. For example, the SoC may include the processor 802, a GPU, one or more of the network connectivity components 806, and one or more of the sensor components 808. In some configurations, the processor 802 is fabricated, in part, utilizing a package-on-package (“PoP”) integrated circuit packaging technique. Moreover, the processor 802 may be a single core or multi-core processor.

The processor 802 may be created in accordance with an ARM architecture, available for license from ARM HOLDINGS of Cambridge, United Kingdom. Alternatively, the processor 802 may be created in accordance with an x86 architecture, such as is available from INTEL CORPORATION of Mountain View, Calif. and others. In some configurations, the processor 802 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 804 include a RAM 814, a ROM 816, an integrated storage memory (“integrated storage”) 818, and a removable storage memory (“removable storage”) 820. In some configurations, the RAM 814 or a portion thereof, the ROM 816 or a portion thereof, and/or some combination the RAM 814 and the ROM 816 is integrated in the processor 802. In some configurations, the ROM 816 is configured to store a firmware, an operating system or a portion thereof (e.g., operating system kernel), and/or a bootloader to load an operating system kernel from the integrated storage 818 or the removable storage 820.

The integrated storage 818 can include a solid-state memory, a hard disk, or a combination of solid-state memory and a hard disk. The integrated storage 818 may be soldered or otherwise connected to a logic board upon which the processor 802 and other components described herein also may be connected. As such, the integrated storage 818 is integrated in the computing device. The integrated storage 818 is configured to store an operating system or portions thereof, application programs, data, and other software components described herein.

The removable storage 820 can include a solid-state memory, a hard disk, or a combination of solid-state memory and a hard disk. In some configurations, the removable storage 820 is provided in lieu of the integrated storage 818. In other configurations, the removable storage 820 is provided as additional optional storage. In some configurations, the removable storage 820 is logically combined with the integrated storage 818 such that the total available storage is made available and shown to a user as a total combined capacity of the integrated storage 818 and the removable storage 820.

The removable storage 820 is configured to be inserted into a removable storage memory slot (not shown) or other mechanism by which the removable storage 820 is inserted and secured to facilitate a connection over which the removable storage 820 can communicate with other components of the computing device, such as the processor 802. The removable storage 820 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 804 can store an operating system. According to various configurations, the operating system includes, but is not limited to, the WINDOWS MOBILE OS, the WINDOWS PHONE OS, or the WINDOWS OS from MICROSOFT CORPORATION, BLACKBERRY OS from RESEARCH IN MOTION, LTD. of Waterloo, Ontario, Canada, IOS from APPLE INC. of Cupertino, Calif., and ANDROID OS from GOOGLE, INC. of Mountain View, Calif. Other operating systems are contemplated.

The network connectivity components 806 include a wireless wide area network component (“WWAN component”) 822, a wireless local area network component (“WLAN component”) 824, and a wireless personal area network component (“WPAN component”) 826. The network connectivity components 806 facilitate communications to and from a network 828, which may be a WWAN, a WLAN, or a WPAN. Although a single network 828 is illustrated, the network connectivity components 806 may facilitate simultaneous communication with multiple networks. For example, the network connectivity components 806 may facilitate simultaneous communications with multiple networks via one or more of a WWAN, a WLAN, or a WPAN.

The network 828 may be a WWAN, such as a mobile telecommunications network utilizing one or more mobile telecommunications technologies to provide voice and/or data services to a computing device utilizing the computing device architecture 800 via the WWAN component 822. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 828 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 828 may be configured to provide voice and/or data communications with any combination of the above technologies. The network 828 may be configured to or adapted to provide voice and/or data communications in accordance with future generation technologies.

In some configurations, the WWAN component 822 is configured to provide dual-multi-mode connectivity to the network 828. For example, the WWAN component 822 may be configured to provide connectivity to the network 828, wherein the network 828 provides service via GSM and UMTS technologies, or via some other combination of technologies. Alternatively, multiple WWAN components 822 may be utilized to perform such functionality, and/or provide additional functionality to support other non-compatible technologies (i.e., incapable of being supported by a single WWAN component). The WWAN component 822 may facilitate similar connectivity to multiple networks (e.g., a UMTS network and an LTE network).

The network 828 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 824 is configured to connect to the network 828 via the WI-FI access points. Such connections may be secured via various encryption technologies including, but not limited, WI-FI Protected Access (“WPA”), WPA2, Wired Equivalent Privacy (“WEP”), and the like.

The network 828 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 826 is configured to facilitate communications with other devices, such as peripherals, computers, or other computing devices via the WPAN.

The sensor components 808 include a magnetometer 830, an ambient light sensor 832, a proximity sensor 834, an accelerometer 836, a gyroscope 838, and a Global Positioning System sensor (“GPS sensor”) 840. It is contemplated that other sensors, such as, but not limited to, temperature sensors or shock detection sensors, also may be incorporated in the computing device architecture 800.

The magnetometer 830 is configured to measure the strength and direction of a magnetic field. In some configurations the magnetometer 830 provides measurements to a compass application program stored within one of the memory components 804 in order to provide a user with accurate directions in a frame of reference including the cardinal directions, north, south, east, and west. Similar measurements may be provided to a navigation application program that includes a compass component. Other uses of measurements obtained by the magnetometer 830 are contemplated.

The ambient light sensor 832 is configured to measure ambient light. In some configurations, the ambient light sensor 832 provides measurements to an application program stored within one the memory components 804 in order to automatically adjust the brightness of a display (described below) to compensate for low-light and high-light environments. Other uses of measurements obtained by the ambient light sensor 832 are contemplated.

The proximity sensor 834 is configured to detect the presence of an object or thing in proximity to the computing device without direct contact. In some configurations, the proximity sensor 834 detects the presence of a user's body (e.g., the user's face) and provides this information to an application program stored within one of the memory components 804 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 834 are contemplated.

The accelerometer 836 is configured to measure proper acceleration. In some configurations, output from the accelerometer 836 is used by an application program as an input mechanism to control some functionality of the application program. For example, the application program may be a video game in which a character, a portion thereof, or an object is moved or otherwise manipulated in response to input received via the accelerometer 836. In some configurations, output from the accelerometer 836 is provided to an application program for use in switching between landscape and portrait modes, calculating coordinate acceleration, or detecting a fall. Other uses of the accelerometer 836 are contemplated.

The gyroscope 838 is configured to measure and maintain orientation. In some configurations, output from the gyroscope 838 is used by an application program as an input mechanism to control some functionality of the application program. For example, the gyroscope 838 can be used for accurate recognition of movement within a 3D environment of a video game application or some other application. In some configurations, an application program utilizes output from the gyroscope 838 and the accelerometer 836 to enhance control of some functionality of the application program. Other uses of the gyroscope 838 are contemplated.

The GPS sensor 840 is configured to receive signals from GPS satellites for use in calculating a location. The location calculated by the GPS sensor 840 may be used by any application program that requires or benefits from location information. For example, the location calculated by the GPS sensor 840 may be used with a navigation application program to provide directions from the location to a destination or directions from the destination to the location. Moreover, the GPS sensor 840 may be used to provide location information to an external location-based service, such as E911 service. The GPS sensor 840 may obtain location information generated via WI-FI, WIMAX, and/or cellular triangulation techniques utilizing one or more of the network connectivity components 806 to aid the GPS sensor 840 in obtaining a location fix. The GPS sensor 840 may also be used in Assisted GPS (“A-GPS”) systems.

The I/O components 810 include a display 842, a touchscreen 844, a data I/O interface component (“data I/O”) 846, an audio I/O interface component (“audio I/O”) 848, a video I/O interface component (“video I/O”) 850, and a camera 852. In some configurations, the display 842 and the touchscreen 844 are combined. In some configurations two or more of the data I/O component 846, the audio I/O component 848, and the video I/O component 850 are combined. The I/O components 810 may include discrete processors configured to support the various interface described below, or may include processing functionality built-in to the processor 802.

The display 842 is an output device configured to present information in a visual form. In particular, the display 842 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 842 is a liquid crystal display (“LCD”) utilizing any active or passive matrix technology and any backlighting technology (if used). In some configurations, the display 842 is an organic light emitting diode (“OLED”) display. Other display types are contemplated.

The touchscreen 844 is an input device configured to detect the presence and location of a touch. The touchscreen 844 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 844 is incorporated on top of the display 842 as a transparent layer to enable a user to use one or more touches to interact with objects or other information presented on the display 842. In other configurations, the touchscreen 844 is a touch pad incorporated on a surface of the computing device that does not include the display 842. For example, the computing device may have a touchscreen incorporated on top of the display 842 and a touch pad on a surface opposite the display 842.

In some configurations, the touchscreen 844 is a single-touch touchscreen. In other configurations, the touchscreen 844 is a multi-touch touchscreen. In some configurations, the touchscreen 844 is configured to detect discrete touches, single touch gestures, and/or multi-touch gestures. These are collectively referred to herein as “gestures” for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 844. As such, a developer may create gestures that are specific to a particular application program.

In some configurations, the touchscreen 844 supports a tap gesture in which a user taps the touchscreen 844 once on an item presented on the display 842. The tap gesture may be used for various reasons including, but not limited to, opening or launching whatever the user taps. In some configurations, the touchscreen 844 supports a double tap gesture in which a user taps the touchscreen 844 twice on an item presented on the display 842. The double tap gesture may be used for various reasons including, but not limited to, zooming in or zooming out in stages. In some configurations, the touchscreen 844 supports a tap and hold gesture in which a user taps the touchscreen 844 and maintains contact for at least a pre-defined time. The tap and hold gesture may be used for various reasons including, but not limited to, opening a context-specific menu.

In some configurations, the touchscreen 844 supports a pan gesture in which a user places a finger on the touchscreen 844 and maintains contact with the touchscreen 844 while moving the finger on the touchscreen 844. The pan gesture may be used for various reasons including, but not limited to, moving through screens, images, or menus at a controlled rate. Multiple finger pan gestures are also contemplated. In some configurations, the touchscreen 844 supports a flick gesture in which a user swipes a finger in the direction the user wants the screen to move. The flick gesture may be used for various reasons including, but not limited to, scrolling horizontally or vertically through menus or pages. In some configurations, the touchscreen 844 supports a pinch and stretch gesture in which a user makes a pinching motion with two fingers (e.g., thumb and forefinger) on the touchscreen 844 or moves the two fingers apart. The pinch and stretch gesture may be used for various reasons including, but not limited to, zooming gradually in or out of a website, map, or picture.

Although the gestures described above have been presented with reference to the use of one or more fingers for performing the gestures, other appendages such as toes or objects such as styluses may be used to interact with the touchscreen 844. As such, the above gestures should be understood as being illustrative and should not be construed as being limiting in any way.

The data I/O interface component 846 is configured to facilitate input of data to the computing device and output of data from the computing device. In some configurations, the data I/O interface component 846 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 848 is configured to provide audio input and/or output capabilities to the computing device. In some configurations, the audio I/O interface component 846 includes a microphone configured to collect audio signals. In some configurations, the audio I/O interface component 846 includes a headphone jack configured to provide connectivity for headphones or other external speakers. In some configurations, the audio interface component 848 includes a speaker for the output of audio signals. In some configurations, the audio I/O interface component 846 includes an optical audio cable out.

The video I/O interface component 850 is configured to provide video input and/or output capabilities to the computing device. In some configurations, the video I/O interface component 850 includes a video connector configured to receive video as input from another device (e.g., a video media player such as a DVD or BLURAY player) or send video as output to another device (e.g., a monitor, a television, or some other external display). In some configurations, the video I/O interface component 850 includes a High-Definition Multimedia Interface (“HDMI”), mini-HDMI, micro-HDMI, DisplayPort, or proprietary connector to input/output video content. In some configurations, the video I/O interface component 850 or portions thereof is combined with the audio I/O interface component 848 or portions thereof.

The camera 852 can be configured to capture still images and/or video. The camera 852 may utilize a charge coupled device (“CCD”) or a complementary metal oxide semiconductor (“CMOS”) image sensor to capture images. In some configurations, the camera 852 includes a flash to aid in taking pictures in low-light environments. Settings for the camera 852 may be implemented as hardware or software buttons.

Although not illustrated, one or more hardware buttons may also be included in the computing device architecture 800. The hardware buttons may be used for controlling some operational aspect of the computing device. The hardware buttons may be dedicated buttons or multi-use buttons. The hardware buttons may be mechanical or sensor-based.

The illustrated power components 812 include one or more batteries 854, which can be connected to a battery gauge 856. The batteries 854 may be rechargeable or disposable. Rechargeable battery types include, but are not limited to, lithium polymer, lithium ion, nickel cadmium, and nickel metal hydride. Each of the batteries 854 may be made of one or more cells.

The battery gauge 856 can be configured to measure battery parameters such as current, voltage, and temperature. In some configurations, the battery gauge 856 is configured to measure the effect of a battery's discharge rate, temperature, age and other factors to predict remaining life within a certain percentage of error. In some configurations, the battery gauge 856 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 812 may also include a power connector, which may be combined with one or more of the aforementioned I/O components 810. The power components 812 may interface with an external power system or charging equipment via a power I/O component 844.

The disclosure presented herein can also be considered to encompass the subject matter set forth in the following clauses:

Clause 1: A computer-implemented method for generating an intent-based document from a document having one or more explicitly formatted document elements, the method comprising:

classifying, by way of a computer, the document as having one of a plurality of layout types;

determining, by way of the computer, an inferred layout intent for the one or more explicitly formatted document elements in the document, the determination of the inferred layout intent based, at least in part, upon the classification of the document; and

generating, by way of the computer, the intent-based document using the determined inferred layout intent for the one or more explicitly formatted document elements in the document.

Clause 2: The computer-implemented method of clause 1, wherein the document is classified as having one of the plurality of layout types based, at least in part, upon the execution, on the computer, of one or more heuristic algorithms that examine a layout of the document to classify the document as having one of the plurality of layout types.

Clause 3: The computer-implemented method of clauses 1 and 2, wherein the document is classified as having one of the plurality of layout types based, at least in part, upon the execution, on the computer, of one or more machine learning classifiers that utilize machine learning to classify the document as having one of the plurality of layout types.

Clause 4: The computer-implemented method of clauses 1-3, wherein the machine learning classifiers are trained based upon human classification of a layout of a corpus of training documents.

Clause 5: The computer-implemented method of clauses 1-4, wherein the inferred layout intent for the one or more explicitly formatted document elements is based, at least in part, upon the execution on the computer of one or more heuristic algorithms that examine patterns or configurations of document elements in the document to determine the inferred layout intent for the one or more explicitly formatted document elements in the document.

Clause 6: The computer-implemented method of clauses 1-5, wherein the one or more heuristic algorithms are selected or configured based, at least in part, upon the classification of the document as having one of the plurality of layout types.

Clause 7: The computer-implemented method of clauses 1-6, wherein the inferred layout intent for the one or more explicitly formatted document elements is determined, at least in part, by executing one or more machine learning classifiers on the computer that utilize machine learning to determine the inferred layout intent for the one or more explicitly formatted document elements in the document.

Clause 8: The computer-implemented method of clauses 1-7, wherein the one or more machine learning classifiers are selected or configured based, at least in part, upon the classification of the document as having one of the plurality of layout types.

Clause 9: The computer-implemented method of clauses 1-8, wherein the one or more machine learning classifiers are trained based upon human classification of the layout intent of explicitly formatted document elements in a corpus of training documents.

Clause 10: The computer-implemented method of clauses 1-9, further comprising generating a certainty score for the inferred layout intent of the one or more explicitly formatted document elements in the document.

Clause 11: A computer storage medium having computer executable instructions stored thereon which, when executed by a computer, cause the computer to:

classify a layout of a document as being one of a plurality of layout types, the document having one or more explicitly formatted document elements contained therein;

determine an inferred layout intent for the one or more explicitly formatted document elements in the document, the determination of the inferred layout intent based, at least in part, upon the classification of the layout of the document; and

generate, by way of the computer, an intent-based document from the document using the determined inferred layout intent for the one or more explicitly formatted document elements in the document.

Clause 12: The computer-storage medium of clause 11, wherein the layout of the document is classified as being one of the plurality of layout types by:

one or more heuristic document layout classification algorithms; or

one or more machine learning based document layout classifiers that have been trained using human classification of a layout of a corpus of training documents.

Clause 13. The computer-storage medium of clauses 11-12, wherein the inferred layout intent for the one or more explicitly formatted document elements in the document is determined by:

one or more heuristic algorithms that examine or configurations of document elements in the document to determine the inferred layout intent for the one or more explicitly formatted document elements in the document; or

one or more machine learning classifiers that utilize machine learning to determine the inferred layout intent for the one or more explicitly formatted document elements in the document, the machine learning classifiers having been trained based upon human classification of the layout intent of explicitly formatted document elements in a corpus of training documents.

Clause 14: The computer-storage medium of clauses 11-13, wherein the one or more heuristic algorithms or the one or more machine learning classifiers are selected or configured based upon the classification of the layout of the document.

Clause 15: The computer-storage medium of clauses 11-14, having further computer executable instructions stored thereon which, when executed by the computer, cause the computer to generate a certainty score associated with the inferred layout intent of the one or more explicitly formatted document elements in the document.

Clause 16: A system for generating an intent-based document from a document having one or more explicitly formatted document elements, the system comprising:

at least one computer having a processor and being configured to execute a document layout classification service on the processor for classifying a layout of the document; and

at least one computer having a processor and being configured to execute a document conversion service on the processor for

determining an inferred layout intent for the one or more explicitly formatted document elements in the document and

generating the intent-based document using the determined inferred layout intent for the one or more explicitly formatted document elements in the document.

Clause 17: The system of clause 16, wherein the document layout classification service is configured to classify the layout of the document as being a paper-like layout or a presentation-like layout.

Clause 18: The system of clauses 16-17, wherein the document layout classification service is configured to utilize one or more heuristic algorithms or one or more machine learning classifiers to classify the layout of the document as being a paper-like layout or a presentation-like layout.

Clause 19: The system of clauses 16-18, wherein the document conversion service is further configured to utilize one or more heuristic algorithms or one or more machine learning classifiers to determine the inferred layout intent for the one or more explicitly formatted document elements in the document.

Clause 20: The system of clauses 16-19, wherein the one or more heuristic algorithms or the one or more machine learning classifiers are selected or configured based upon a classification of the layout of the document as being a paper-like layout or a presentation-like layout.

Clause 21: A system, comprising:

means for classifying a layout of a document as being one of a plurality of layout types, the document having one or more explicitly formatted document elements contained therein;

means for determining an inferred layout intent for the one or more explicitly formatted document elements in the document, the determination of the inferred layout intent based, at least in part, upon the classification of the layout of the document; and

means for generating, by way of the computer, an intent-based document from the document using the determined inferred layout intent for the one or more explicitly formatted document elements in the document.

Clause 22: The system of clause 21, wherein the layout of the document is classified as being one of the plurality of layout types by:

one or more heuristic document layout classification algorithms; or

one or more machine learning based document layout classifiers that have been trained using human classification of a layout of a corpus of training documents.

Clause 23. The system of clauses 21-22, wherein the inferred layout intent for the one or more explicitly formatted document elements in the document is determined by:

one or more heuristic algorithms that examine or configurations of document elements in the document to determine the inferred layout intent for the one or more explicitly formatted document elements in the document; or

one or more machine learning classifiers that utilize machine learning to determine the inferred layout intent for the one or more explicitly formatted document elements in the document, the machine learning classifiers having been trained based upon human classification of the layout intent of explicitly formatted document elements in a corpus of training documents.

Clause 24: The system of clauses 21-23, wherein the one or more heuristic algorithms or the one or more machine learning classifiers are selected or configured based upon the classification of the layout of the document.

Clause 25: The system of clauses 21-24, comprising means for generating a certainty score associated with the inferred layout intent of the one or more explicitly formatted document elements in the document.

Based on the foregoing, it should be appreciated that technologies for inferring layout intent have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example configurations and applications illustrated and described, and without departing from the true spirit and scope of the present invention, which is set forth in the following claims.

What is claimed is:

1. A computer-implemented method for generating an intent-based document from a document having one or more explicitly formatted document elements, the method comprising:
classifying, by way of a computer, the document as having one of a plurality of layout types;
determining, by way of the computer, an inferred layout intent for the one or more explicitly formatted document elements in the document, the determination of the inferred layout intent based, at least in part, upon the classification of the document; and
generating, by way of the computer, the intent-based document using the determined inferred layout intent for the one or more explicitly formatted document elements in the document.

2. The computer-implemented method of claim 1, wherein the document is classified as having one of the plurality of layout types based, at least in part, upon the execution, on the computer, of one or more heuristic algorithms that examine a layout of the document to classify the document as having one of the plurality of layout types.

3. The computer-implemented method of claim 1, wherein the document is classified as having one of the plurality of layout types based, at least in part, upon the execution, on the computer, of one or more machine learning classifiers that utilize machine learning to classify the document as having one of the plurality of layout types.

4. The computer-implemented method of claim 3, wherein the machine learning classifiers are trained based upon human classification of a layout of a corpus of training documents.

5. The computer-implemented method of claim 1, wherein the inferred layout intent for the one or more explicitly formatted document elements is based, at least in part, upon the execution on the computer of one or more heuristic algorithms that examine patterns or configurations of document elements in the document to determine the inferred layout intent for the one or more explicitly formatted document elements in the document.

6. The computer-implemented method of claim 5, wherein the one or more heuristic algorithms are selected or configured based, at least in part, upon the classification of the document as having one of the plurality of layout types.

7. The computer-implemented method of claim 1, wherein the inferred layout intent for the one or more explicitly formatted document elements is determined, at least in part, by executing one or more machine learning classifiers on the computer that utilize machine learning to determine the inferred layout intent for the one or more explicitly formatted document elements in the document.

8. The computer-implemented method of claim 7, wherein the one or more machine learning classifiers are selected or configured based, at least in part, upon the classification of the document as having one of the plurality of layout types.

9. The computer-implemented method of claim 7, wherein the one or more machine learning classifiers are trained based upon human classification of the layout intent of explicitly formatted document elements in a corpus of training documents.

10. The computer-implemented method of claim 1, further comprising generating a certainty score for the inferred layout intent of the one or more explicitly formatted document elements in the document.

11. A computer storage medium having computer executable instructions stored thereon which, when executed by a computer, cause the computer to:
classify a layout of a document as being one of a plurality of layout types, the document having one or more explicitly formatted document elements contained therein;
determine an inferred layout intent for the one or more explicitly formatted document elements in the document, the determination of the inferred layout intent based, at least in part, upon the classification of the layout of the document; and
generate, by way of the computer, an intent-based document from the document using the determined inferred layout intent for the one or more explicitly formatted document elements in the document.

12. The computer-storage medium of claim 11, wherein the layout of the document is classified as being one of the plurality of layout types by:
one or more heuristic document layout classification algorithms; or
one or more machine learning based document layout classifiers that have been trained using human classification of a layout of a corpus of training documents.

13. The computer-storage medium of claim 11, wherein the inferred layout intent for the one or more explicitly formatted document elements in the document is determined by:
one or more heuristic algorithms that examine or configurations of document elements in the document to determine the inferred layout intent for the one or more explicitly formatted document elements in the document; or
one or more machine learning classifiers that utilize machine learning to determine the inferred layout intent for the one or more explicitly formatted document elements in the document, the machine learning classifiers having been trained based upon human classification of the layout intent of explicitly formatted document elements in a corpus of training documents.

14. The computer-storage medium of claim 13, wherein the one or more heuristic algorithms or the one or more machine learning classifiers are selected or configured based upon the classification of the layout of the document.

15. The computer-storage medium of claim 11, having further computer executable instructions stored thereon which, when executed by the computer, cause the computer to generate a certainty score associated with the inferred layout intent of the one or more explicitly formatted document elements in the document.

16. A system for generating an intent-based document from a document having one or more explicitly formatted document elements, the system comprising:
at least one computer having a processor and being configured to execute a document layout classification service on the processor for classifying a layout of the document; and
at least one computer having a processor and being configured to execute a document conversion service on the processor for
determining an inferred layout intent for the one or more explicitly formatted document elements in the document, and
generating the intent-based document using the determined inferred layout intent for the one or more explicitly formatted document elements in the document.

17. The system of claim 16, wherein the document layout classification service is configured to classify the layout of the document as being a paper-like layout or a presentation-like layout.

18. The system of claim 17, wherein the document layout classification service is configured to utilize one or more heuristic algorithms or one or more machine learning classifiers to classify the layout of the document as being a paper-like layout or a presentation-like layout.

19. The system of claim 16, wherein the document conversion service is further configured to utilize one or more heuristic algorithms or one or more machine learning classifiers to determine the inferred layout intent for the one or more explicitly formatted document elements in the document.

20. The system of claim 19, wherein the one or more heuristic algorithms or the one or more machine learning classifiers are selected or configured based upon a classification of the layout of the document as being a paper-like layout or a presentation-like layout.
